(19) United States
(12) Patent Application Publication
(10) Pub. No.: US 2007/0195741 A1
(43) Pub. Date: Aug. 23, 2007

(54) Method of scheduling data traffic in wireless communication system

(75) Inventors: Hee-Kwun Cho, Bupyeong-gu (KR); Jang-Hoon Yang, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/698,789

(22) Filed: Jan. 26, 2007

(30) Foreign Application Priority Data
Jan. 26, 2006 (KR) 2006-8475

(51) Int. Cl. H04B 7/212

(52) U.S. Cl. 370/337

(57) ABSTRACT

A method of scheduling data traffics at a base station in a wireless communication system is disclosed. The method includes preferentially assigning radio resources to a mobile station having a good channel state when the amount of data traffic generated is greater than a first threshold; preferentially assigning radio resources to a mobile station that has not been given radio resources for a long time when the amount of data traffic generated is less than the first threshold; and aggregating data traffic corresponding to the same Modulation and Coding Scheme (MCS) level to the same data traffic region and assigning radio resources to the data traffic when the amount of control information for data traffic assignment is greater than a second threshold.

### PRIORITY

This application claims the benefit under 35 U.S.C. § 119(a) of a Korean Patent Application filed in the Korean Intellectual Property Office on Jan. 26, 2006 and assigned Serial No. 2006-8475, the disclosure of which is incorporated herein by reference.

### BACKGROUND OF THE INVENTION

1. Field of the Invention

The present invention generally relates to a wireless communication system, and in particular, to a method of scheduling downlink data traffic in a wireless communication system.

2. Description of the Related Art

Generally, in a wireless communication system, a Base Station (BS) schedules the transmission of data traffic, i.e., packets, to a Mobile Station (MS) having a destination address.

One of representative packet scheduling algorithms is a Proportional Fair (PF) algorithm. The PF algorithm improves throughput by considering the radio channel state of each MS while guaranteeing long-term fairness.

However, the PF algorithm is not applicable to a wireless communication system adopting Orthogonal Frequency Division Multiple Access (OFDMA) because data can be transmitted to a plurality of MSs during a frame and the amount of resources assigned to each MS is variable in the OFDMA communication system.

In particular, a scheduler of a BS in an OFDMA wireless communication system has to determine a destination MS for each frame data and the amount of resources and a data rate to be assigned to each MS. Moreover, assignment information and data traffic are transmitted during the same frame in the OFDMA wireless communication system. Thus, an increase in the amount of assignment information leads to a reduction in the amount of radio resources required for the transmission of the data traffic.

Consequently, the OFDMA wireless communication system has to consider minimizing the amount of assignment information while taking into account fairness. Therefore, there is a need for a method of applying a PF scheduling algorithm which is capable of meeting the various requirements of an OFDMA wireless communication system.

### SUMMARY OF THE INVENTION

An object of the present invention is to address at least the above problems and/or disadvantages and to provide at least the advantages described below. Accordingly, an object of the present invention is to provide a scheduling method capable of controlling fairness and throughput in a wireless communication system.

Another object of the present invention is to provide a scheduling method capable of improving throughput by controlling MAP overhead in a wireless communication system.

According to another aspect of the present invention, there is provided a method of scheduling data traffics at a base station in a wireless communication system. The method includes preferentially assigning radio resources to a mobile station having a good channel state when the amount of data traffic generated is greater than a first threshold; preferentially assigning radio resources to a mobile station that has not been given radio resources for a long time when the amount of data traffic generated is less than the first threshold; and aggregating data traffic corresponding to the same Modulation and Coding Scheme (MCS) level in the same data traffic region and assigning radio resources to the data traffic when the amount of control information for data traffic assignment is greater than a second threshold.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a schematic diagram illustrating the structure of a wireless communication system according to the present invention;

FIGS. 2A and 2B illustrate an example of data burst allocation with respect to α in a wireless communication system according to the present invention; and

FIGS. 3A and 3B illustrate an example of data burst allocation with respect to β in a wireless communication system according to the present invention.

### DETAILED DESCRIPTION OF THE PREFERRED EMBODIMENT

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

The present invention provides a method of efficiently scheduling data traffic by considering various factors in a wireless communication system. The various factors may include the average number of slots assigned to Mobile Stations (MSs), the current channel state, resource assignment information, and the like. By taking into account those various factors, the present invention adaptively controls fairness and throughput during scheduling. Moreover, the present invention improves system processing performance by controlling signaling overhead during scheduling.

The present invention can be applied to all types of wireless communication systems that transmit and receive data traffic over a radio channel, and particularly, may be applied to a wireless communication system using Orthogonal Frequency Division Multiple Access (OFDMA).

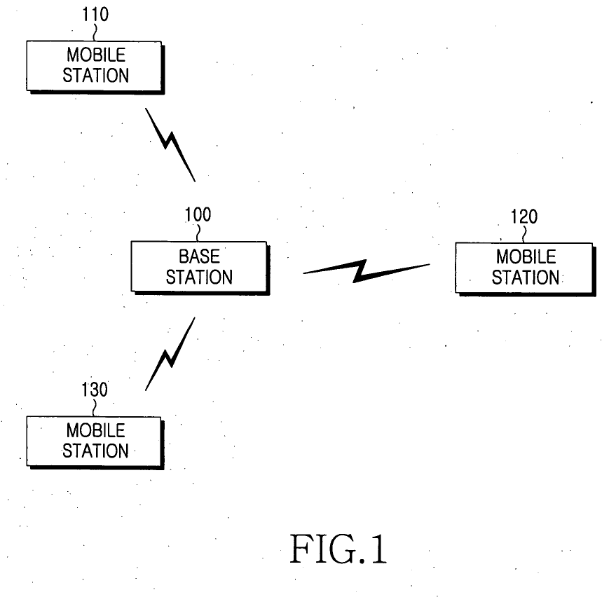

FIG. 1 is a schematic diagram illustrating the structure of a wireless communication system according to the present invention.

Referring to FIG. 1, the wireless communication system includes a Base Station (BS) 100 and a plurality of Mobile Stations (MSs) 110, 120, and 130, wherein the BS 100 communicates with the MSs 110, 120, and 130 over a radio channel. Here, the BS 100 transmits a packet received from a wired network to an MS over a radio channel. The BS 100 has to manage information for each of the MSs 110, 120, and 130 and the information means parameters expressed in Equation (1).

A priority metric of a scheduling algorithm suggested by the present invention can be given by Equation (1):

$$max \{ \frac{{{λ}_{k} [ t ]}^{β} {{d}_{k} [ t ]}^{α} {μ}_{k} [ t ]}{{B}_{k} [ t ]} \} , \qquad ( 1 )$$

where k indicates an MS, and λₖ[t] is a parameter indicating whether the signaling overhead of the MS k is considered at time t and is adjusted by a superscript β having a constant value range of 0≠1. When β is equal to or close to 0, a scheduler of the BS 100 does not consider the signaling overhead, i.e., MAP overhead. When β is equal to or close to 1, the scheduler of the BS 100 considers the MAP overhead. dₖ[t] is a parameter indicating whether the priority of the MS k is considered at the time t and is adjusted by a superscript α having a constant value range of 0≈1. When α is equal to or close to 0, the scheduler of the BS 100 gives preferential consideration to improvement of system processing performance. When 0≦α≦1, however, the scheduler of the BS 100 gives preferential consideration to fairness in assigning radio resources to the MS k.

μₖ[t] indicates a data rate that can be supported for the MS k at the time t. Here, the BS 100 can recognize the data rate based on Channel State Information (CSI) fed back from the MS k. Bₖ[t] indicates the average number of slots assigned to the MS k during a predetermined time T_{c}. Bₖ[t] can be expressed as Equation (2):

$${B}_{k} [ t ] = ( 1 - \frac{1}{{T}_{c}} ) \cdot {B}_{k} [ t - 1 ] + \frac{1}{{T}_{c}} {b}_{k} [ t - 1 ] , \qquad ( 2 )$$

where bₖ[t] indicates the number of slots assigned to the MS k at the time t. As discussed above, the present invention schedules data traffic for MSs according to priorities determined using Equation (1).

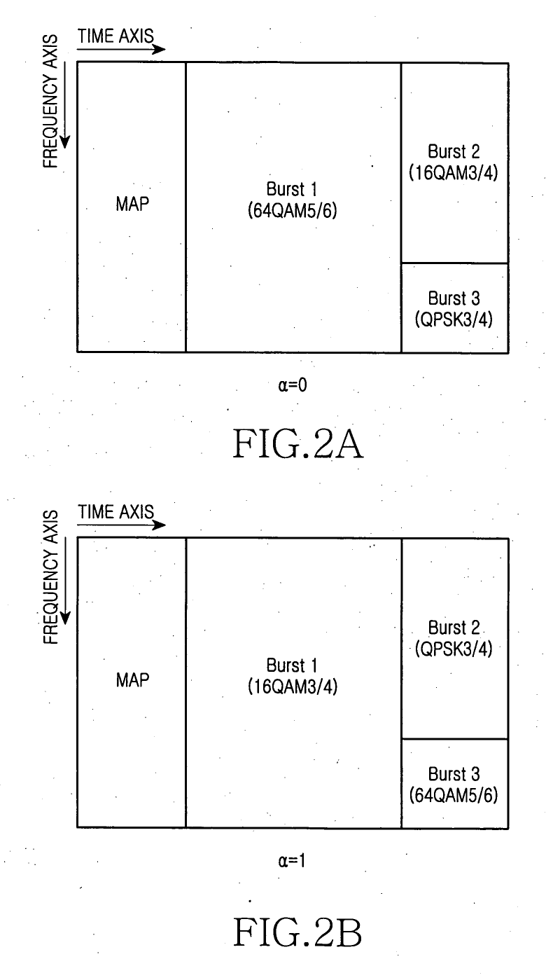

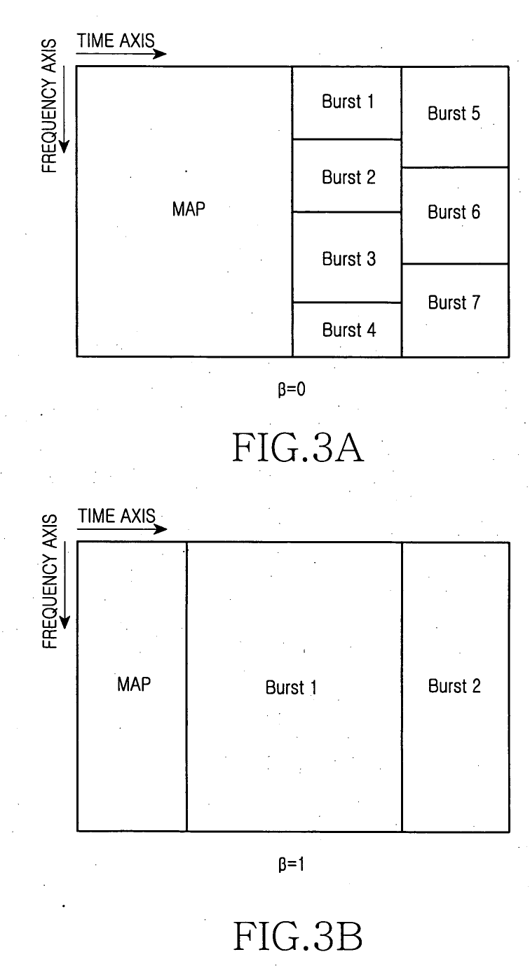

Hereinafter, data burst allocation for α=0 or α=1 and data burst allocation for β=0 or β=1 will be described with reference to FIGS. 2 and 3.

FIGS. 2A and 2B illustrate an example of data burst allocation with respect to α in a wireless communication system according to the present invention.

Prior to a description with reference to FIGS. 2A and 2B, a frame in the wireless communication system includes a plurality of symbols along a time axis and a plurality of sub-channels along a frequency axis. A slot includes at least one symbol along the time axis and at least one sub-channel along the frequency axis. The slot may be a basic unit for resource assignment.

Referring to FIGS. 2A and 2B, for α=0 in Equation (1), the scheduler of the BS 100 assigns more resources to an MS having a good channel state than an MS having a poor channel state. In contrast, for α=1 in Equation (1), the scheduler of the BS 100 preferentially assigns resources to MSs that have not been given resources for a long time, thereby fairly assigning radio resources to a plurality of MSs. Preferably, the scheduler of the BS 100 sets α to 0 for resource assignment that improves throughput when much data traffic is generated, and sets α to 1 for fair resource assignment when a little data traffic is generated.

FIG. 2A shows the case of α=0, in which the scheduler preferentially assigns radio resources to a data burst corresponding to a higher Modulation and Coding Scheme (MCS) level by giving preferential consideration to throughput improvement. In contrast, FIG. 2B shows the case of α=1, in which the scheduler performs resource assignment by giving preferential consideration to fairness.

FIGS. 3A and 3B illustrate an example of data burst allocation with respect to β in a wireless communication system according to the present invention.

Referring to FIGS. 3A and 3B, for β=0 in Equation (1), the scheduler does not consider MAP overhead in a data frame. Here, the scheduler allocates data bursts corresponding to the same MCS level to different data burst regions, increasing MAP overhead in comparison to when allocating the data bursts to the same data burst region. Since an OFDMA communication system generally uses the same radio resources for assignment of data traffic and control information, an increase in the amount of control information reduces the amount of radio resources that can be used for the data traffic. Consequently, reducing the amount of control information is the key to improve system processing performance.

For example, for β=1 in Equation (1), the scheduler allocates the data bursts corresponding to the same MCS level to the same data burst region on a frame, thereby reducing MAP overhead.

In summary, when too much data traffic is generated and thus the remaining capacity of a transfer buffer is less than a threshold, the scheduler sets α to 0 in order to preferentially assign radio resources to a data burst corresponding to a higher MCS level. Conversely, when a little data traffic is generated, the scheduler sets α to 1 in order to preferentially assign radio resources to MSs that have not been given radio resources for a long time, thereby fairly assigning radio resources to a plurality of MSs.

The scheduler can also minimize MAP overhead by setting β to 1. Thus, when the amount of control information, i.e., MAP overhead, exceeds a predetermined threshold due to data burst allocation, the scheduler sets β to 1 to minimize the MAP overhead and allocates data bursts corresponding to the same MCS level or data bursts of the same MS to the same data burst region. Here, the predetermined threshold may be determined according to system implementation and radio resources remaining after the minimization of the MAP overhead can be used for data burst allocation.

As described above, the present invention provides a new data traffic scheduling algorithm in a wireless communication system, thereby controlling both fairness and throughput. Moreover, signaling overhead can be reduced using the scheduling algorithm.

While the invention has been shown and described with reference to an exemplary embodiment thereof, it will be understood by those skilled in the art that various changes in form and details may be made therein without departing from the spirit and scope of the invention.

What is claimed is:

1. A method of scheduling data traffic at a base station in a wireless communication system, the method comprising:
preferentially assigning radio resources to a mobile station having a good channel state when the amount of data traffic generated is greater than a first threshold;
preferentially assigning radio resources to a mobile station that has not been given radio resources for a long time when the amount of data traffic generated is less than the first threshold; and
aggregating data traffic corresponding to a same Modulation and Coding Scheme (MCS) level in a same data traffic region and assigning radio resources to the data traffic when the amount of control information for data traffic assignment is greater than a second threshold.

2. The method of claim 1, wherein the channel state of the mobile station is determined by channel state information fed back from the mobile station.

3. The method of claim 1, wherein the radio resources are slots including frequency bands and time intervals.

4. The method of claim 1, wherein the scheduling based on the amount of data traffic generated and the amount of control information is performed using:
$$max \{ \frac{{{λ}_{k} [ t ]}^{β} {{d}_{k} [ t ]}^{α} {μ}_{k} [ t ]}{{B}_{k} [ t ]} \}$$
where k indicates a mobile station, λk[t] is a parameter indicating the amount of control information of the mobile station k at time t, a superscript β of λₖ[t] is a parameter having a constant value range of 0-1, dₖ[t] is a parameter indicating whether the priority of the mobile station k is considered at time t, a superscript α of dₖ[t] is a parameter having a constant value range of 0-1, μₖ[t] indicates a data rate that can be supported for the mobile station k at time t, and Bₖ[t] indicates the average number of slots assigned to the mobile station k during a predetermined time T_{c} and can be expressed as follows:
$${B}_{k} [ t ] = ( 1 - \frac{1}{{T}_{c}} ) \cdot {B}_{k} [ t - 1 ] + \frac{1}{{T}_{c}} {b}_{k} [ t - 1 ]$$
where bₖ[t] indicates the number of slots assigned to the mobile station k at time t.

5. The method of claim 1, wherein the first threshold and the second threshold are determined based on the capacity of a transfer buffer.

6. The method of claim 1, wherein the mobile station having a good channel state has a high MCS level.
